(19) United States
(12) Patent Application Publication
(10) Pub. No.: US 2026/0050239 A1
(43) Pub. Date: Feb. 19, 2026

(54) RATE SETTING DEVICE FOR A TIMEPIECE

(71) Applicant: ETA SA Manufacture Horlogère Suisse, Grenchen (CH)

(72) Inventors: Julien CHRISTAN, Bienne (CH); Ivan Villar, Brügg (CH)

(73) Assignee: ETA SA Manufacture Horlogère Suisse, Grenchen (CH)

(21) Appl. No.: 19/311,150

(22) Filed: Aug. 27, 2025

(30) Foreign Application Priority Data
Sep. 17, 2024 (EP) 24200895.1

(51) Int. Cl. G04B 18/02

(52) U.S. Cl. CPC G04B 18/02

(57) ABSTRACT

A timepiece incorporating a mechanical movement and including a device for setting its rate, including a rotationally mobile part and a setting mobile (4) controlling the angular position of the rotationally mobile part. The setting device includes a lever (5) fitted with a linking train (6) and by a actuator button, between an uncoupled position and a coupled position. The setting mobile is kinematically joined, via the linking train (6), to a mobile (7) on a correction device, including a control arbor fitted with a crown enabling the mobile to be actuated, or to a drive mobile of an indicator which can be driven by the correction device when correcting the data displayed by the indicator to set the rate of the timepiece by actuating the button.

### CROSS REFERENCE TO RELATED APPLICATIONS

This application claims priority to European Patent Application No. 24200895.1 filed Sep. 17, 2024, the entire contents of which are incorporated herein by reference.

### TECHNICAL FIELD OF THE INVENTION

The invention relates to the field of mechanical horology. More specifically, it relates to a device for setting the rate of a timepiece that can be actuated from the outside without having to open the timepiece. The invention also relates to a movement comprising such a device and to a timepiece incorporating such a movement.

### TECHNOLOGICAL BACKGROUND

There are several common examples of rate setting mechanisms that are designed to be actuated without being required to open the timepiece to gain access to the movement.

DocumentFR 2184949 relates to a mechanism enabling the rate of the regulator to be controlled from outside the watch. The rate is set using the winding arbor when it is moved to a longitudinal position dedicated solely to setting the rate, in this case a stable fourth position. Even if the change to this specific position is signalled by the passage of a hard point, there is still a high risk of moving the winding arbor by mistake and thus of resetting the rate of the watch.

Document U.S. Pat. No. 2,933,883 provides for setting the rate of the watch when correcting the time displayed using the winding arbor. However, the setting amplitude is limited to a predetermined value. Since the rate of the watch is set in conjunction with a correction to the time displayed, it is impossible to correct one of these parameters without changing the other. However, an erroneous time display can be due in particular to the watch stopping and not to the rate of the watch. Moreover, a temporal error in the time display usually does not make it possible to determine an error in the setting of the mechanical oscillator, unless the temporal error specifically results from the watch having constantly run over a predetermined period. In fact, a temporal error in the time display can be due to an error in the setting of the regulating organ of the watch and to the period that has elapsed since the watch last displayed a correct time, on the assumption that the watch has functioned normally throughout this elapsed period.

Document CH 152943 describes a mechanism that enables the minute hand to be reset to zero using a button while making a correction to the rate of the watch in proportion to the correction made to the time display. This mechanism can only be actuated at given brief intervals, for example when the time of a reference clock changes, and provided that said minute hand is sufficiently close to zero. Much like in the previous anteriority, there is no direct relation between the error in the time displayed and the correction to be made to the rate of the watch, which depends on the phase-shift of the mechanical oscillator per unit of time resulting from an error in its oscillation frequency relative to a nominal frequency (reference frequency) provided for this mechanical oscillator (phase-shift generally expressed in seconds per day).

Document DE 873677 provides a teaching similar to that of the previous document.

The watch rate setting mechanisms disclosed in the two previous documents have several major drawbacks, firstly because they set the rate of the watch according to and simultaneously with a correction to the minute hand at a precise reference time, and this correction usually does not indicate the value of the correction to be made to rate of the watch. These setting mechanisms are also cumbersome because they each extend over a major part of the horizontal surface of the mechanical movement of the watch. Lastly, these mechanisms are complex and require a complicated assembly with low manufacturing tolerances. Furthermore, it is unclear whether the mechanism in document DE 873677, as shown in the only figure, is functional.

Finally, U.S. Pat. No. 2,441,847 describes a watch rate setting device with a specific control organ positioned diametrically opposite the winding arbor. A graduation on the middle opposite the setting crown indicates the level of the correction made. However, due to the small graduation size and the lack of any direct indication of the value of the correction made, reading is difficult and the risk of error is high. Moreover, the addition of a second arbor encumbers the style of the watch and adds to the challenges of water-resistance. In addition, there is a high risk of inadvertently resetting the watch.

### SUMMARY OF THE INVENTION

The objective of the invention is to remedy the various aforementioned drawbacks of the mechanisms in the prior art and to provide a device enabling the rate of a timepiece incorporating a mechanical movement to be corrected and therefore set with great precision and advantageously in a secure manner, without being required to open the timepiece, without encumbering the style of the timepiece and without having to carry out such a setting at a given precise time, and above all without the timepiece rate setting being simultaneous with a correction to the time displayed and directly dependent on this correction.

The purposes of the invention are achieved by a timepiece comprising:
a mechanical movement fitted with a regulating organ formed by an inertial mass and a balance spring;
a device for correcting data displayed by at least one indicator on a display device comprised in the timepiece, this correction device being controlled by a control arbor fitted with a crown that can be translationally and rotationally actuated by a user; and
a device for setting the rate of the timepiece, comprising a rotationally mobile part, defining at least one physical property of the balance spring, and a setting mobile capable of controlling the angular position of the rotationally mobile part, so as to be able to act on the balance spring to change the frequency of the regulating organ according to the angular position of the rotationally mobile part.

This timepiece is remarkable in that the setting device further comprises a lever fitted with at least part of a linking train and capable of being rotated by a button, which can be actuated by the user, between an uncoupled position and a coupled position, in which the setting mobile is kinematically joined, via the linking train, to a mobile on the correction device or on a device for driving said indicator, this mobile being capable of being driven by the control arbor once the latter has been moved to a given axial correction position, so as to enable the rate of the timepiece to be set by pressing on the button, thus moving the lever to its coupled position, and by translating the crown, to move the control arbor to the given axial correction position, and then by rotating the crown.

This arrangement makes it possible to set/correct the rate of the timepiece, irrespective of the initial position of the minute hand and with no risk of an inadvertent reset, as the value of the correction does not depend on the initial position of the minute hand and is not a function of a correction made to the position of this hand, which can, if necessary, be returned to a correct position after the rate of the watch has been set.

According to a particular embodiment of the invention, the setting mobile comprises a cam arranged to engage with a cam follower (also referred to as a ‘feeler’) which is attached to the rotationally mobile part.

According to a particular embodiment of the invention, the setting organ is arranged to define the active length of the balance spring. According to another particular embodiment of the invention, the setting organ comprises a balance spring stud to which is attached an arm for setting the stiffness of at least one portion of the balance spring, this setting arm changing the stiffness of the balance spring according to the angular position of the balance spring stud and accordingly of the rotationally mobile part.

In a main embodiment, said mobile of the correction device or of the device for driving said indicator and the setting mobile are positioned at different levels in the mechanical movement, the linking train comprising an arbor fitted at each of its two ends with a connecting wheel and pivotally mounted around an axis of rotation. In a preferred variant, said axis of rotation is fixed in the mechanical movement and the lever is mounted on the arbor so as to be rotationally mobile around the axis of rotation.

In a first advantageous embodiment, the timepiece is fitted with a date indicator and said given axial correction position is a correction position of the date indicator. In its coupled position, the lever joins the setting mobile kinematically to a date drive wheel.

In a second advantageous embodiment, the timepiece is fitted with a minute indicator and said given axial correction position is a correction position of the position of said minute indicator. Remarkably, the value of a correction to the rate in seconds per day is indicated by the variation in the position of the minute indicator in minutes. Alternatively, a graduation specific to the rate correction function can be provided. After setting the rate of the watch and after returning the lever to its uncoupled position, the minute indicator can be moved to the correct position if necessary.

### BRIEF DESCRIPTION OF THE FIGURES

The purposes, advantages and characteristics of the present invention will also become apparent from the detailed description of an embodiment provided solely by way of non-limiting example, with reference to the appended drawings in which:

FIG. 1 shows part of a horology movement comprising a rate setting device according to the invention;
FIGS. 2 and 3 show a lever of the setting device in the uncoupled position and the coupled position, respectively;

FIG. 4 is a cross-sectional view of the lever and its linking train, the mobile of the time setting train and the rate setting mobile;

FIG. 5 is a perspective view of the lever and its linking train; and

FIG. 6 shows a variant of the regulating organ with its balance spring and part of the setting device joined to the balance spring.

### DETAILED DESCRIPTION OF THE INVENTION

The rate of mechanical timepieces fitted with a sprung balance regulator is conventionally set by moving an index arranged to act on the active length of the balance spring. This operation generally takes place in a workshop, where the watch case is opened to gain access to the setting system. In addition to having to immobilise the timepiece, merely opening and closing the case can affect the rate of the watch and make the correction less accurate. In the past, various solutions have been proposed for setting the rate from outside the watch, but none of them has become the norm or persists today, despite the advantages of such a solution.

The present invention provides a device for setting the rate of a mechanical timepiece which can be actuated from the outside. FIG. 1 shows a partial view of a horology movement comprising such a setting device. The mechanical movement of this timepiece is fitted with a regulating organ comprising an inertial mass 1, in the form of a balance, and a balance spring 2. The balance (mechanical oscillator) is pivotally mounted between a plate 8 and a bar 9.

The timepiece conventionally comprises a device for correcting at least one datum displayed respectively by at least one indicator of a display device comprised in this timepiece. The correction device is controlled by a control arbor fitted with a crown and can be actuated in translation and in rotation by a user. In the embodiment shown, the correction device includes a time setting device, namely, a device for correcting the display of the conventional time indicators (in particular the hour hand and the minute hand) and also, where appropriate, a device for correcting at least one other indicator on the timepiece, in particular a date indicator and/or a second time zone. The correction device usually comprises a correction train, which includes a time setting train comprising at least one mobile 7, and the control arbor can be axially moved to at least one correction position from a neutral position enabling the mechanical movement of the timepiece to be wound. The crown is attached to the control arbor and can be actuated in translation and rotation by a user.

The device for setting the rate of the timepiece comprises a rotationally mobile part 3, defining at least one physical property of the balance spring, and a setting mobile 4 capable of controlling the angular position of the rotationally mobile part, so as to be able to act on the balance spring 2 to change the frequency of the regulating organ according to the angular position of the rotationally mobile part. The rotationally mobile part 3 is pivotally mounted on the bar 9 and is coaxial with the balance wheel. Generally speaking, a setting organ, fixedly attached to the rotationally mobile part 3, makes it possible to act on the balance spring 2 to change the frequency of the regulating organ slightly according to the angular position of the rotationally mobile part and thus to adjust the rate of the timepiece (also referred to as the watch).

Traditionally, but not shown, the setting organ can consist of two pins between which the balance spring runs and against which this balance spring alternately contacts. By rotating the index with the setting device, the active length of the balance spring and the oscillation frequency of the regulator can be adjusted.

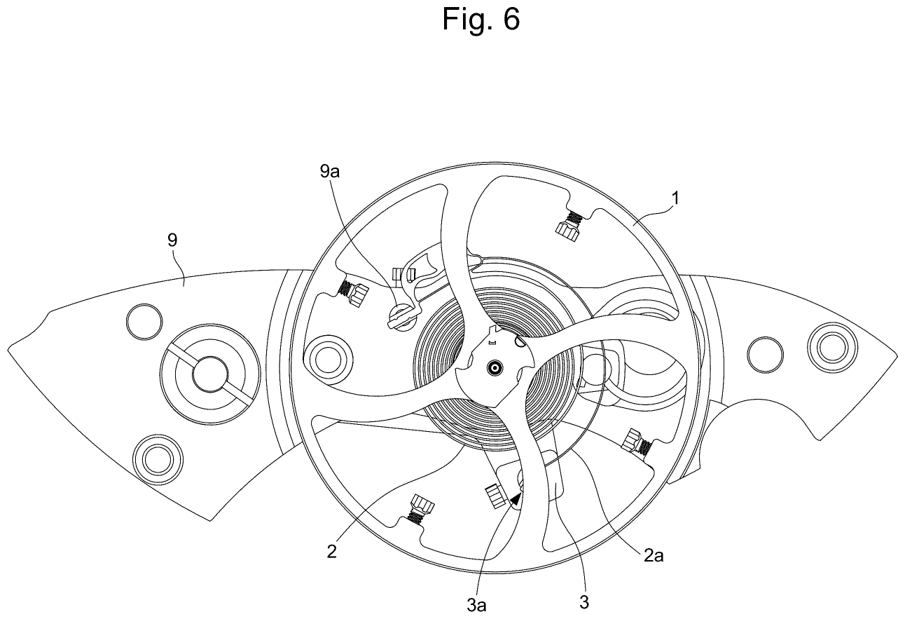

In the embodiment shown, the outer end of the balance spring is attached by a balance spring stud 9a to the bar 9 as can be seen in FIG. 6. The balance spring 2 has a setting arm 2a, the end of which is attached to the setting organ, which is formed in this case by a balance spring stud 3a fixedly mounted on the rotationally mobile part 3. Rotating this rotationally mobile part acts on the setting arm of the balance spring via the balance spring stud 3a, with the effect of slightly changing the stiffness of the balance spring and thereby the frequency of the regulator. EP 4009115 A1 provides a particular example of this type of rate setting.

Whatever the embodiment chosen for the balance spring and the type of rate setting provided, the angular position of the rotationally mobile part determines the frequency of the regulating organ (regulator). This angular position is controlled by the pivotally mounted setting mobile 4 on the bar 9. In the embodiment shown, the setting mechanism carries a spiral-shaped cam 4a designed to engage with a cam follower 3b attached to the rotationally mobile part 3.

A resilient element 12 mounted on the bar 9 acts on the rotationally mobile part 3 to keep the cam follower 3b in contact with the cam 4a. In an alternative variant not shown, the rotationally mobile part is positively linked to the setting mobile 4.

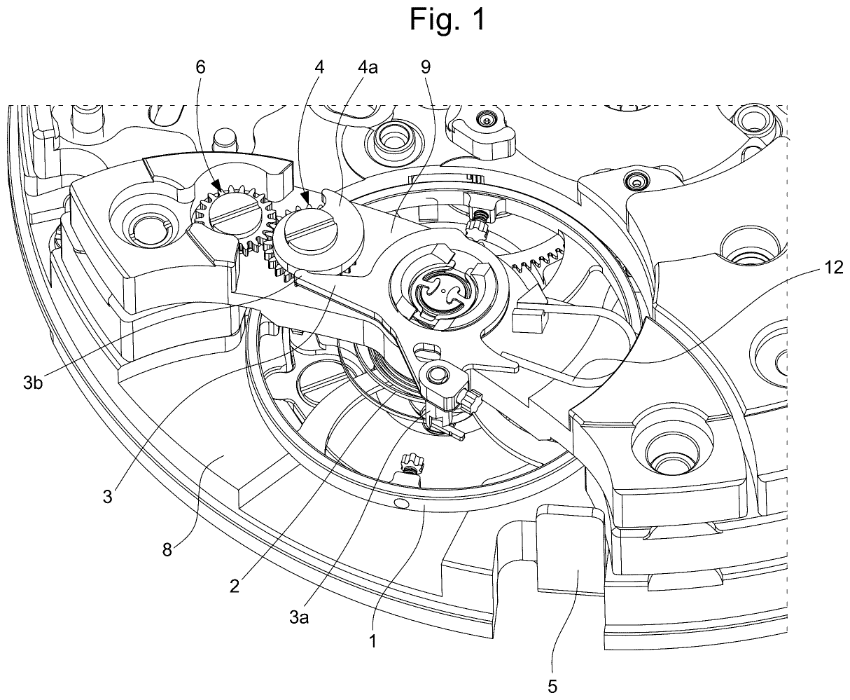

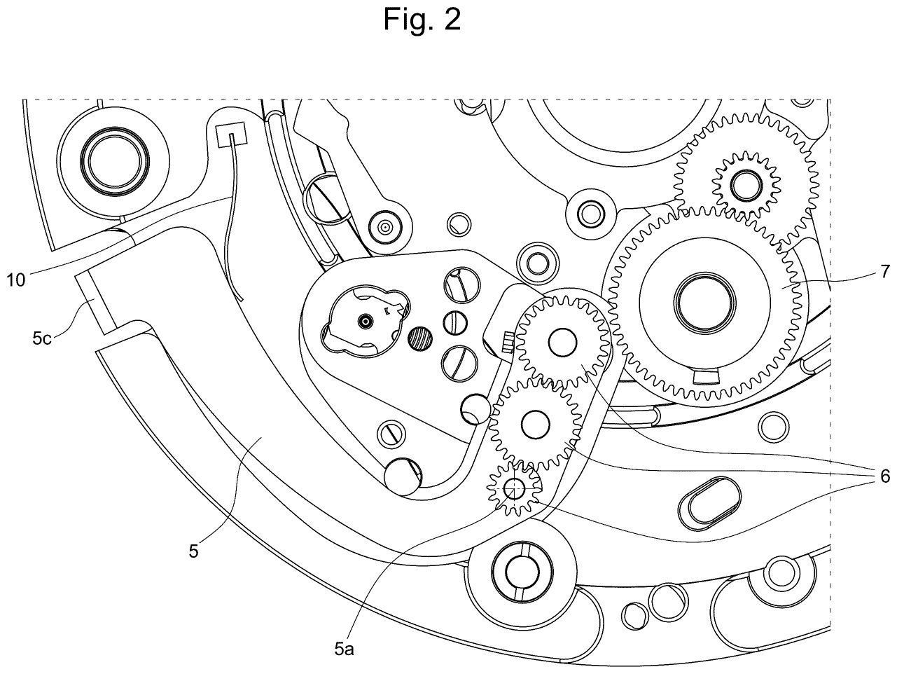

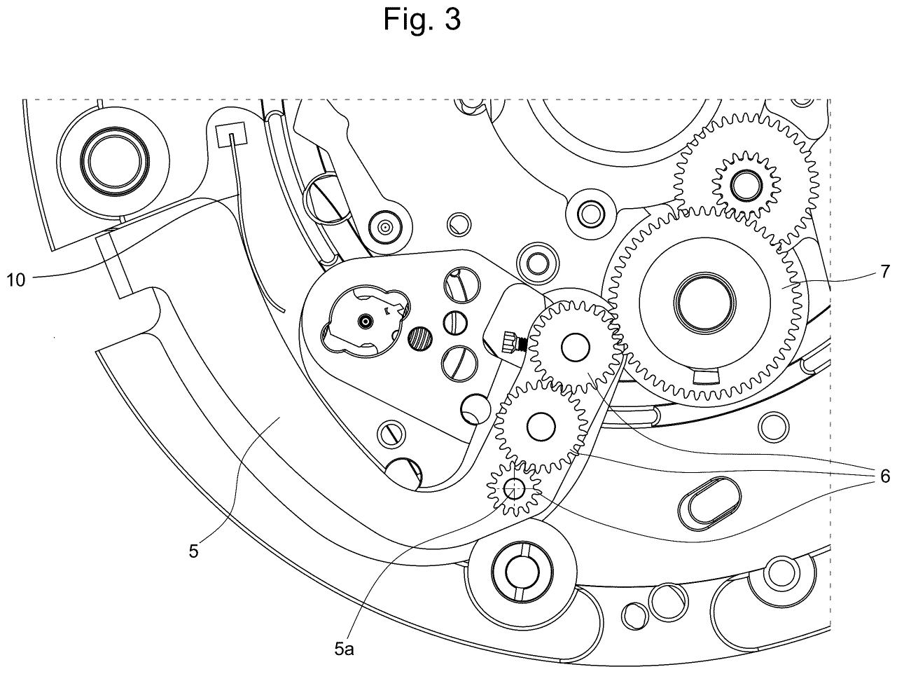

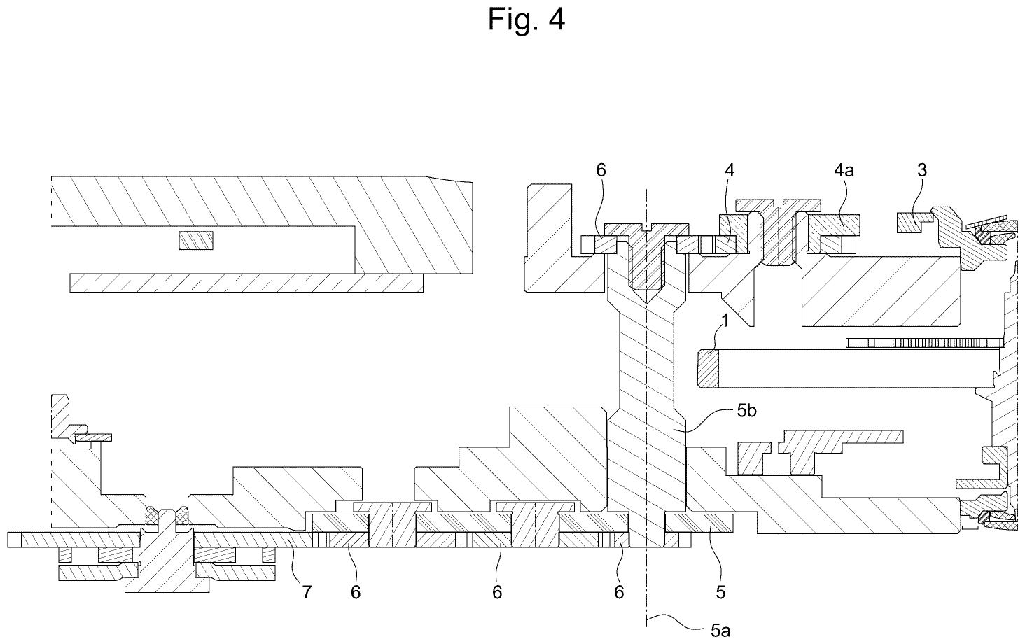

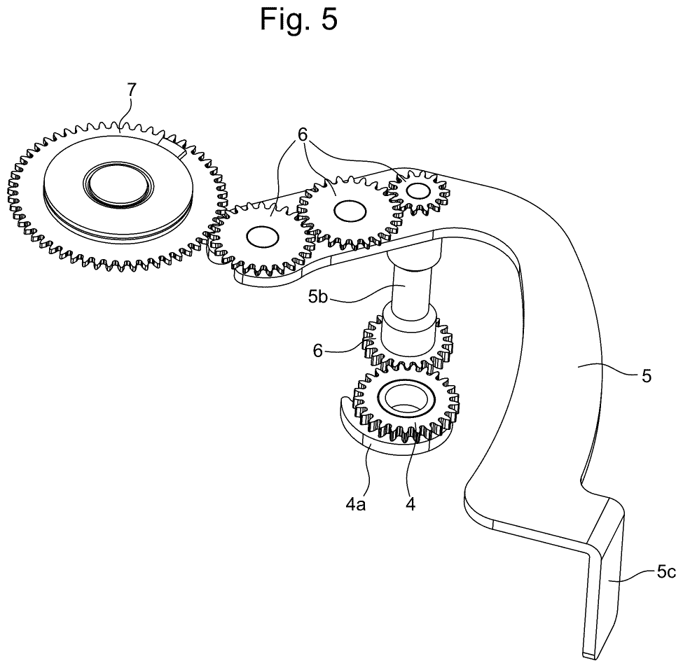

The rate setting device according to the invention also comprises a lever 5 which is rotationally mobile around an axis of rotation 5a and can be moved by a button on the timepiece that can be actuated by a user from outside the timepiece, and which acts on an end part 5c of the lever against an elastic return means 10, as can be seen in FIGS. 2 and 3.

The lever 5 is fitted with part of a linking train 6 designed to kinematically join the setting mobile 4 to a mobile 7 on the time-setting train. When the button is not subjected to axial pressure, the lever 5 is in an uncoupled position in which the kinematic linkage between the setting mobile 4 and the time-setting train is interrupted. When the button is actuated by axial pressure, the lever 5 is moved to a coupled position in which the setting mobile 4 is kinematically joined to the mobile 7 on the setting train via the linking train 6. The configuration of the linking train can be determined by the person skilled in the art according to the design of the timepiece movement.

Thus, in general, the lever 5 can be rotated between an uncoupled position and a coupled position, in which the setting mobile 4 is kinematically joined, via the linking train 6, to a mobile 7 on the correction device or on a device for driving said indicator, this mobile 7 being capable of being driven by the control arbor once the latter has been moved to a given axial correction position, so as to enable the rate of the timepiece to be set by pressing on the button, thus moving the lever 5 to its coupled position, and by translating the crown, to move the control arbor to the given axial correction position, and then by rotating the crown.

In the embodiment shown, it can be seen that the setting mobile 4 is not on the same level as the mobile 7 on the time-setting train, which is advantageous for the design of the mechanical movement, and that the linking train 6 comprises an arbor 5b which is fitted at both of its ends with two linking wheels, attached to this arbor, to accommodate this difference in level. The arbor 55b is concentrically mounted with the rotational axis 5a, in which it is fixed in the mechanical movement. The lever 5 is mounted on the arbor such that it is rotationally mobile around the axis of rotation independently of the two connecting wheels. In the embodiment shown, the linking train 6 is permanently engaged with a pinion of the setting mobile 4 and the coupling takes place at the level of the mobile 7 on the time-setting train. Obviously, other configurations are possible without departing from the scope of the invention.

To set the rate of the watch in the main embodiment shown, the button must be pressed to operate the lever 5, thereby moving it into its coupled position, while simultaneously pulling on the crown to move the control arbor into the correction position so as to set the rate of the mechanical movement and therefore the rate of the timepiece. Then, while keeping pressure on the button, the crown must be turned to set the desired rate for the timepiece/watch. In the variant shown, the particular correction position is a time setting/correction position for the time indicator. In other variants, other control arbor correction positions can be chosen, in particular the date correction position (if the timepiece features a date indicator). This dual actuation, which requires the use of both hands, prevents any involuntary setting of the watch rate.

In one alternative, the lever is bistable, in its uncoupled position and in its coupled position, and in this case actuating the button causes this bistable lever to move alternately from one stable position to the other. In this way, when setting the rate using the crown to actuate the control arbor, it is not necessary to keep pressure on the button. However, this alternative has a major drawback in that the watch rate cannot be securely set, since inadvertent pressure on the button can lead to inadvertent correction of the rate when the time is subsequently corrected. It could be said that resetting a watch when setting the rate is not really a drawback since the need to set the rate usually arises from finding that the watch is not telling the right time. So the watch needs to be set to the right time anyway, whether or not the rate is set.

The rate can be set either forward or back, according to the direction in which the crown is actuated.

One major advantage of the invention is the precision with which the rate correction can be carried out. To this end, a different mobile can be chosen to drive the linking train 6 than a mobile on the time-setting train, in particular a date drive wheel with a low rotational speed that can be used to achieve high precision in correcting the rate.

Another advantage of the invention is that existing time display means can be used to measure and control the value of the correction made to the watch rate. When the setting mobile 4 is joined to the time setting train as the rate of the timepiece is being set, the value of the correction made to the rate is directly proportional to the variation in the time indication, in particular the position of the minute indicator. There is therefore no need for additional displays to check the rate correction value. Moreover, the large, easy-to-read minute display makes it possible to read the rate correction value with great precision. A specific graduation can be provided or, more simply, the minute graduation can be used by choosing an appropriate reduction ratio.

The rate setting device according to the invention thus enables the rate to be set without opening the timepiece and, in the preferred embodiment described, with no risk of an inadvertent reset, without making the style more cumbersome by adding specific indicators (although provision is made for adding a button to the case of the timepiece, but this button is not necessarily protruding) and, in particular, with great precision in the correction made and in reading the corrected value.

1. A timepiece comprising:
a mechanical movement fitted with a regulating organ formed by an inertial mass (1) and a balance spring (2);
a device for correcting data displayed by at least one indicator on a display device comprised in the timepiece, this correction device being controlled by a control arbor fitted with a crown that can be translationally and rotationally actuated by a user; and
a device for setting the rate of the timepiece, comprising a rotationally mobile part (3), defining at least one physical property of the balance spring, and a setting mobile (4) capable of controlling the angular position of the rotationally mobile part, so as to be able to act on the balance spring (2) to change the frequency of the regulating organ according to the angular position of the rotationally mobile part;
wherein the setting device further comprises a lever (5) fitted with at least part of a linking train (6) and capable of being rotated by a button, which can be actuated by the user, between an uncoupled position and a coupled position, in which the setting mobile (4) is kinematically joined, via the linking train, to a mobile (7) on the correction device or on a device for driving said indicator, the mobile being capable of being driven by the control arbor once the control arbor has been moved to a given axial correction position, so as to enable the rate of the timepiece to be set by pressing on the button, thus moving the lever to an coupled position, and by translating the crown, in order to move the control arbor to the given axial correction position, and then by rotating the crown.

2. The timepiece according to claim 1, wherein said mobile (7) on the correction device or on the device for driving said indicator and the setting mobile (4) are positioned at different levels in the mechanical movement, said linking train (6) comprising an arbor (5b) fitted at its two ends with two respective connecting wheels, attached to this arbor, and pivotally mounted around an axis of rotation (5a).

3. The timepiece according to claim 2, wherein said axis of rotation (5a) is fixed in the mechanical movement and the lever is mounted on the arbor so as to be rotationally mobile around the axis of rotation independently of the two connecting wheels.

4. The timepiece according claim 1, wherein the setting mobile (4) comprises a cam (4a) arranged to engage with a cam follower (3b) attached to the rotationally mobile part (3).

5. The timepiece according to claim 1, wherein the lever (5) can be moved between the uncoupled position and the coupled position against a resilient return means (10), this lever remaining in the coupled position only as long as sufficient pressure is exerted on the button to overcome the return means.

6. The timepiece according to claim 1, wherein the rotationally mobile part (3) carries a fixed balance spring stud (3a) to which is attached an arm (2a) for setting the stiffness of at least a portion of the balance spring (2), this setting arm being arranged to change the stiffness of the balance spring (2) according to the angular position of the balance spring stud and accordingly of the rotationally mobile part.

7. The timepiece according to claim 1, which is fitted with a date indicator, wherein said given axial correction position is a correction position of the date indicator; and in that the lever in its coupled position kinematically joins the setting mobile to a date drive wheel.

8. The timepiece according to claim 1, which is fitted with a minute indicator; wherein said given axial correction position is a correction position of the position of the minute indicator; and in that the value of a rate correction is indicated by the variation in the position of the minute indicator.
